(19) United States
(12) Patent Application Publication
(10) Pub. No.: US 2006/0279466 A1
(43) Pub. Date: Dec. 14, 2006

(54) Antenna apparatus for portable terminal

(75) Inventors: Yong-Jin Kim, Seoul (KR); Seung-Hwan Kim, Suwon-si (KR); Joung-Sub Shin, Yongin-si (KR); Jinu Kim, Daejeon (KR); Wan-Jin Choi, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/339,142

(22) Filed: Jan. 25, 2006

(30) Foreign Application Priority Data
Jun. 13, 2005 (KR) 2005-50420

(51) Int. Cl. H01Q 1/24

(52) U.S. Cl. 343/702; 343/895

(57) ABSTRACT

An antenna apparatus for a portable terminal. The antenna apparatus includes a first helical antenna which is mounted on the portable terminal and takes the form of a coil and a second helical antenna which is wound the same axis as the first helical antenna and is surrounded by the first helical antenna. One end of the second helical antenna is connected to one end of the first helical antenna.

### PRIORITY

This application claims priority under 35 U.S.C. §119 to an application entitled “Antenna Apparatus for Portable Terminal” filed in the Korean Intellectual Property Office on Jun. 13, 2005 and assigned Serial No. 2005-50420, the contents of which are incorporated herein by reference.

### BACKGROUND OF THE INVENTION

1. Field of the Invention

The present invention generally relates to a portable terminal, and in particular, to an antenna apparatus for a portable terminal.

2. Description of the Related Art

In general, a “portable terminal” means an electronic apparatus which provides electrical communication between users and service providers. Various types of contents such as voice communication, a short message service, a mobile banking service, TV watching, an on-line game service, and an on-demand video service are provided to users using portable terminals.

Conventional portable terminals may be classified in various types according to their appearance. For example, portable communication terminals are classified into bar-type terminals, flip-type terminals, and folder-type terminals. In the bar-type terminal, input/output devices such as a communication circuit, a transmitting unit, and a receiving unit are mounted in a single housing. In the flip-type terminal, a flip cover is mounted in the bar-type terminal. In the folder-type terminal, a pair of housings is opened and closed through rotation and input/output devices are appropriately arranged over the pair of housings. Recently, a sliding-type terminal has been developed to improve portability and convenience in use and to satisfy various users' preferences, together with the folder-type terminal.

Mobile communication services using portable terminals have diversified content, such as an on-line game service, moving picture file transmission, mobile banking, an on-demand video service, and a digital multimedia broadcasting (DMB) service. Commercialization of content providing services using portable terminals has been fostered due to widespread use of portable terminals. Various expanding user demands continue such diversification of mobile communication services.

A portable terminal includes an antenna apparatus for securing reception sensitivity and communication quality at superior levels even in an electric wave environment that changes with the surroundings. The antenna apparatus included in the portable terminal has various specifications according to frequency bands used by service providers.

Antenna apparatuses can be classified into internal antennas mounted in housings of portable terminals and external antennas protruding from housings of portable terminals. Loop antennas, inverted L antennas, and planar inverted F antennas are used as the internal antennas. An antenna whose antenna housing accommodates an antenna element, e.g., a helical antenna, or an antenna that can be inserted or extracted is used as the external antennas. An antenna housing of the external antenna is exposed to the exterior of a terminal housing or protrudes from the terminal housing.

Since mobile communication services using portable terminals such as voice communication, short message transmission, transmission or reception of games/multimedia files are provided using frequency bands assigned to existing service providers, reception sensitivity and communication quality can be secured at superior levels through already mounted antenna apparatuses. With recent attempts to commercialize terrestrial DMB services, many efforts have been made to provide the terrestrial Digital Multimedia Broadcasting (DMB) services through portable terminals.

However, a frequency band used for the terrestrial DMB services is 180 MHz to 186 MHz or 204 MHz to 210 MHz and is different from a frequency band used for mobile communication services, causing difficulty in providing the terrestrial DMB services using conventional portable terminals. In other words, since antenna apparatuses mounted in conventional portable terminals are set to operate in a frequency band higher than 800 MHz, they are not suitable for the terrestrial DMB services using 180 MHz to 186 MHz or 204 MHz to 210 MHz. Moreover, because of a need for antennas larger than apparatuses mounted in conventional portable terminals, antenna apparatuses suitable for the terrestrial DMB services are difficult to apply to conventional portable terminals.

### SUMMARY OF THE INVENTION

It is, therefore, an object of the present invention to provide an antenna apparatus which is mounted in a portable terminal and is capable of receiving terrestrial digital multimedia broadcasting (DMB).

It is another object of the present invention to provide an antenna apparatus which is capable of receiving terrestrial DMB, is suitable for miniaturization, and is easy to apply to a portable terminal.

To achieve the above and other objects, there is provided an antenna for a portable terminal. The antenna apparatus includes a first helical antenna which is mounted on the portable terminal and is arranged as a coil and a second helical antenna which is wound around the same axis as the first helical antenna and is surrounded by the first helical antenna. One end of the second helical antenna is connected to one end of the first helical antenna.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a portable terminal including an antenna apparatus according to a first embodiment of the present invention;

FIG. 2 is a cross-sectional view of the antenna apparatus of FIG. 1;

FIG. 3 is a cross-sectional view of a second antenna housing of the antenna apparatus of FIG. 1 is extended;

FIG. 4 is a cross-sectional view of an antenna apparatus of a portable terminal according to a second embodiment of the present invention; and

FIG. 5 is a cross-sectional view showing a first antenna housing of the antenna apparatus of FIG. 4 is extended.

### DETAILED DESCRIPTION OF THE PREFERRED EMBODIMENT

Preferred embodiments of the present invention will now be described in detail with reference to the annexed drawings. In the following description, a detailed description of known functions and configurations incorporated herein has been omitted for conciseness.

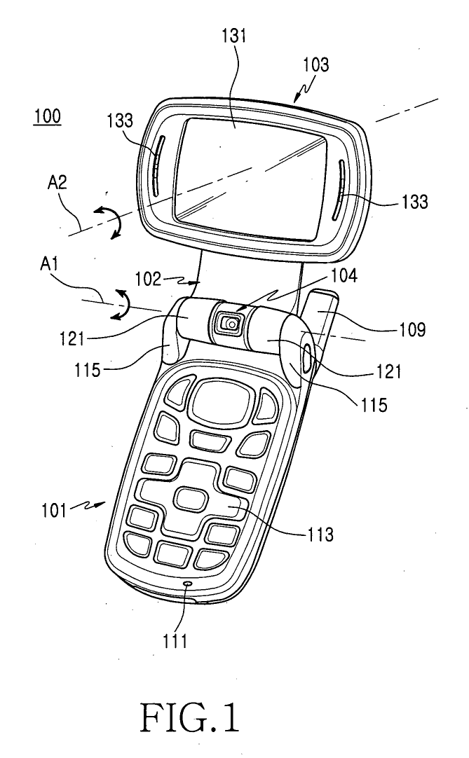

FIG. 1 is a perspective view of a portable terminal 100 including an antenna apparatus 109 according to the present invention. As shown in FIG. 1, the portable terminal 100 includes a first housing 101 and a second housing 103. The second housing 103 is rotatably mounted with the first housing 101 through a connection member 102.

A transmitting unit 111 having a microphone embedded therein and a keypad 113 are mounted on the front face of the first housing 101. A pair of side hinge arms 115 is positioned spaced apart and opposite to each other on the front face of the first housing 101. The side hinge arms 115 protrude from the front face of the first housing 101. The antenna apparatus 109 is mounted adjacent to the side hinge arms 115 in an upper portion of the first housing 101.

The connection member 102 includes a center hinge arm 121 at one end. The center hinge arm 121 is rotatably combined between the side hinge arms 115, and thus the connection member 102 rotates with respect to a first rotation axis Al on the first housing 101. As the center hinge arm 121 is rotatably combined between the side hinge arms 115, the first rotation axis A1 is provided. A camera lens 104 may be mounted in the center hinge arm 121. Since the camera lens 104 can also rotate with respect to the first rotation axis A1, a user can photograph in various directions.

A display device 131 is mounted on one face of the second housing 103. Speaker devices 133 are mounted at both sides of the display device 131. The second housing 103 is mounted with the inner face of the connection member 102 facing the first housing 101. As the connection member 102 rotates with respect to the first rotation axis A1, the second housing 103 rotates around the first rotation axis Al. As the second housing 103 circles around the first rotation axis A1, the second housing 103 opens or closes the transmitting unit 111, the keypad 113, the display device 131, and the speaker devices 133.

While being mounted to the inner face of the connection member 102, the second housing 103 is configured to rotate with respect to a second rotation axis A2 that extends perpendicularly to the inner face of the connection member 102. Given that the vertical length of a screen is larger than the horizontal length of the screen in a general display device of a portable terminal, a user can conveniently view moving picture files or a program provided through terrestrial DMB using the display device 131 when the second housing 103 is rotated 90° with respect to the second rotation axis A2.

When the second housing 103 rotates with respect to the second rotation axis A2 and thus the horizontal length of a screen is larger than the vertical length of the screen as shown in FIG. 1, the speaker devices 133 are positioned at both sides of the display device 131. Consequently, stereo sound or three-dimensional sound can be provided through the speaker devices 133.

The portable terminal 100 includes the antenna apparatus 109 which provided for terrestrial DMB service in addition to a mobile communication service.

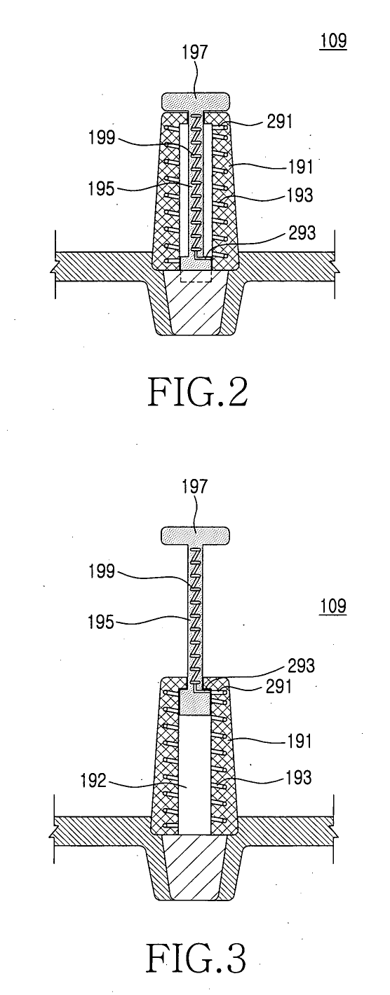

Referring to FIGS. 2 and 3, the antenna apparatus 109 includes a first helical antenna 193 fixed onto the first housing 101 and a second helical antenna 199 that can be inserted into or extracted from the first helical antenna 193 by linearly moving along the longitudinal direction of the first helical antenna 193. To mount the first helical antenna 193 and the second helical antenna 199, the antenna apparatus 109 includes a first antenna housing 191 and a second antenna housing 195.

The first antenna housing 191 is fixed onto the first housing 101 while accommodating the first helical antenna 193. Although not shown in FIGS. 2 and 3, the first helical antenna 193 is connected to a transceiving end of the portable terminal 100 through a connection means provided at an end of the first antenna housing 191. A through hole 192 (see FIG. 3) extends through the center of the first antenna housing 191 along the longitudinal direction of the first antenna housing 191. The first helical antenna 193 winds around the through hole 192 and is accommodated in the first antenna housing 191.

The second antenna housing 195 is accommodated in the through hole 192 of the first antenna housing 191, linearly moves along the longitudinal direction of the first antenna housing 191, and accommodates the second helical antenna 199.

A knob 197 is provided on the second antenna housing 195 to allow a user to extend the second antenna housing 195 when necessary. In other words, in a poor electric wave environment, the user can secure superior signal quality by extending the second helical antenna 199. When the second helical antenna 199 is inserted so as to be surrounded by the first helical antenna 193, the knob 197 is seated on the top of the first antenna housing 191.

When the second helical antenna 199 is extracted from the first helical antenna 193, its bottom is connected to the top of the first helical antenna 193. A first connection end 291, exposed to the through hole 192, is provided on the top of the first helical antenna 193. A second connection end 293, exposed to the outer circumference of the second antenna housing 195, is provided at the bottom of the second helical antenna 199. When the second helical antenna 199 is extended from the first helical antenna 193, the second connection end 293 is electrically connected to the first connection end 291.

Although the second helical antenna 199 linearly moves along the longitudinal direction of the first helical antenna 193 in the current embodiment of the present invention, the first helical antenna 193 and the second helical antenna 199 may be fixed. In other words, in FIG. 2, the antenna apparatus 109 may be configured such that the top of the first helical antenna 193 and the top of the second helical antenna 199 are connected to each other. At this time, the bottom of the first helical antenna 193 is connected to the transceiving end of the portable terminal and the second helical antenna 199 is connected to the transceiving end of the portable terminal 100 through the first helical antenna 193. When both the first helical antenna 193 and the second helical antenna 99 are fixed, the first antenna housing 191 and the second antenna housing 195 may be configured as one body.

Since the second helical antenna 199 can be inserted into or extended from the first helical antenna 193 or a double helical antenna apparatus is configured by winding the first helical antenna 193 and the second helical antenna 199 having different diameters around the same axis, an antenna suitable for a radio communication service using a low frequency band, e.g., terrestrial DMB receipt, can be mounted in a portable terminal.

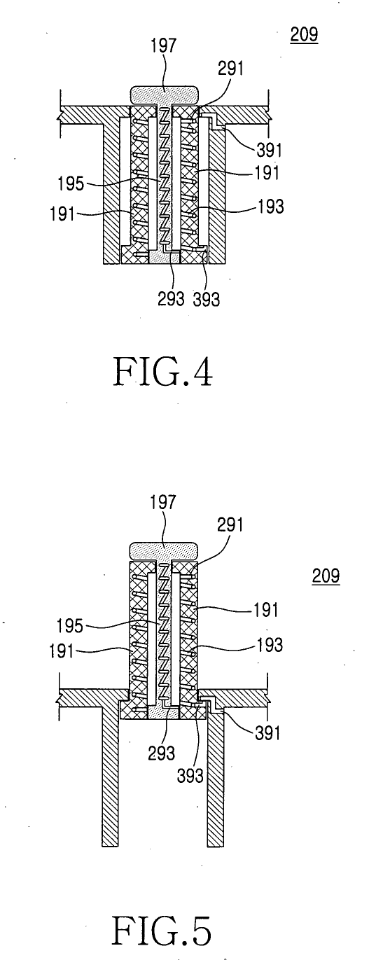

FIGS. 4 and 5 are cross-sectional views of an antenna apparatus 209 of a portable terminal according to the present invention. The antenna apparatus 209 has the similar structure as the antenna apparatus 109, but it is different from the antenna apparatus 109 in that the first antenna housing 191 can be inserted into or extended from a portable terminal. Thus, in a detailed explanation of the antenna apparatus 209, identical reference numerals are used for identical components and explanations of the identical components will not be repeated.

As shown in FIGS. 4 and 5, in the antenna apparatus 209 according to the second embodiment of the present invention, the first antenna housing 191 can be inserted into and extended from the portable terminal. A third connection end 393 is provided at the bottom of the first antenna housing 191 and a transceiving end 391 is mounted adjacent to the outer circumference of the portable terminal.

When the first antenna housing 191 is inserted into the portable terminal, the first helical antenna 193 and the second helical antenna 199 are not connected to the transceiving end 391. When the user desires to view terrestrial DMB, the user extended the first antenna housing 191 from the portable terminal. When the first antenna housing 191 is extended from the portable terminal, the third connection end 393 is connected to the transceiving end 391. At this time, the second antenna housing 195 can be extended from the first antenna housing 191 like in the first embodiment of the present invention. Thus, when the user extends the second antenna housing 195 when necessary, the second helical antenna 195 is connected to the transceiving end 391 through the first helical antenna 193.

Since the first antenna housing 191 may be inserted into or extended from the portable terminal, it is possible to prevent the antenna apparatus 209 from being damaged by an external shock and allow a user to easily carry the portable terminal, by inserting both antennas.

As described above, according to the present invention, one of a pair of helical antennas having different diameters are wound around the other, thereby being suitable for a radio communication service using a low frequency band such as terrestrial DMB and being easily mounted in a portable terminal. In other words, by reducing a space of a portable terminal occupied by a terrestrial DMB antenna, the size of the portable terminal can be reduced even when the terrestrial DMB antenna is mounted in the portable terminal. Moreover, since at least one of a pair of helical antennas can be extended, various forms of antenna apparatuses can be configured.

While the invention has been shown and described with reference to certain preferred embodiments thereof, it will be understood by those skilled in the art that various changes in form and details may be made therein without departing from the spirit and scope of the invention.

What is claimed is:

1. An antenna apparatus for a portable terminal, the antenna apparatus comprising:
a first helical antenna which is mounted on the portable terminal and formed as a coil; and
a second helical antenna wound around the same axis as the first helical antenna and surrounded by the first helical antenna,
wherein one end of the second helical antenna is connected to one end of the first helical antenna.

2. The antenna apparatus of claim 1, wherein the second helical antenna linearly moves along the longitudinal direction of the first helical antenna and the bottom of the second helical antenna is connected to the top of the first helical antenna when the second helical antenna linearly moves and is extended from the first helical antenna.

3. The antenna apparatus of claim 1, further comprising:
a first antenna housing which accommodates the first helical antenna and includes a through hole that passes through the center of the first antenna housing along the longitudinal direction of the first antenna housing; and
a second antenna housing which accommodates the second helical antenna and is inserted into or extended from the through hole when linearly moving along the longitudinal direction of the first antenna housing.

4. The antenna apparatus of claim 3, further comprising a knob provided at an end of the second antenna housing, wherein the knob is seated on the top of the first antenna housing when the second antenna housing is inserted into the through hole.

5. The antenna apparatus of claim 3, further comprising:
a first connection end which is provided on the top of the first helical antenna and is exposed to the through hole; and
a second connection end which is provided on the bottom of the second helical antenna and is exposed to the outer circumference of the second antenna housing,
wherein the second connection end is electrically connected to the first connection end when the second antenna housing is extended from the first antenna housing.

6. The antenna apparatus of claim 3, wherein the first antenna housing is fixed onto the portable terminal.

7. The antenna apparatus of claim 3, wherein the first antenna housing can be inserted into and extended from the portable terminal.

8. The antenna apparatus of claim 7, wherein the bottom of the first helical antenna is connected to a transceiving end of the portable terminal when the first antenna housing is extended from the portable terminal.

9. The antenna apparatus of claim 1, wherein the bottom of the first helical antenna is connected to a transceiving end of the portable terminal and the top of the first helical antenna and the top of the second helical antenna are electrically connected to each other.
